(19) United States
(12) Patent Application Publication
(10) Pub. No.: US 2009/0324665 A1
(43) Pub. Date: Dec. 31, 2009

(54) ANTIBACTERIAL, ANTI-ABSORBENT AND ANTIMICROBIAL BREAST SUPPORTS, BRAS AND RELATED APPAREL

(76) Inventor: Mehran Taghdiri, Los Angeles, CA (US)

Correspondence Address: BUCHALTER NEMER, 18400 VON KARMAN AVE., SUITE 800, IRVINE, CA, 92612, US

(21) Appl. No.: 12/147,020

(22) Filed: Jun. 26, 2008

(51) Int. Cl. A01N 25/34; A41C 3/00; A41C 3/08; A01P 1/00

(52) U.S. Cl. 424/404; 450/93; 450/31

(57) ABSTRACT

A breast support system, bra and related apparel are disclosed that comprise a support member having an outer surface and an inner surface, wherein the support member comprises at least one antibacterial material, at least one anti-absorbent material, at least one antimicrobial material or a combination thereof.

### FIELD OF THE SUBJECT MATTER

The field of the subject matter is antibacterial, anti-absorbent and antimicrobial breast supports, bras and related apparel.

### BACKGROUND

Women are always looking for a bra or breast support that will remain clean, dry and sanitary throughout the day; however, there aren't many materials and designs that provide those conditions. Cotton is a natural material that breathes, but bras made out of cotton provide less support with increasing cup size. Synthetic materials, such as nylon, can easily provide support for larger cup sizes, but these materials don't breathe well and may provide a good environment for bacteria to grow, if the bra is not washed after each use or if the environmental conditions are hot and/or humid.

A China patent application entitled “Brasserie Pad” discloses utilizing a series of holes and blind holes in an insertable bra pad in order to provide ventilation to the wearer's skin. However, these holes and blind holes are not incorporated throughout the entire bra material. These bra pads also are not considered antibacterial, but instead are designed to minimize perspiration build-up—a decidedly different function.

Another Chinese patent application entitled “Brasserie Pad Material” discloses utilizing a thermoplastic material as the base material for a bra. The concept is that this material can be utilized to produce a bra that breathes and therefore, allows its wearer to remain more comfortable while using the bra. The thermoplastic materials are infused with “anti-aging” materials designed to extend the useful lifetime of the bra.

U.S. Pat. No. 6,811,463 discloses bras that have pockets of air between the fabric layers in order to provide good contour and shape, along with impact protection. The air bladders provide the impact resistance to the bra but they do not impart any additional breathability or improved sanitary functions.

U.S. Pat. No. 7,278,899 discloses a bra designed with a silicone gel between two layers of material. This particular bra is designed to be adhesive to the skin of the wearer, such that the bra can be worn and provide support without straps and additional material support. Although this bra utilizes a silicone gel material, which can provide a cooling and dry effect on the skin of the wearer, there are no antibacterial or sanitary improvements imparted to the bra by the use of this material. One issue is the layering of many types of materials. These layers can trap perspiration and bacteria, which foster a breeding ground for bacteria and other microbes.

There is still a need in the women's apparel industry for a breathable, sanitary, antibacterial and antimicrobial breast support, bra and related apparel that can provide adequate support, attractive contour, and the flexibility of being utilized in a number of different apparel items, such as halter tops, shirts, strapless dresses and the like.

### BRIEF DESCRIPTION OF THE FIGURES

FIG. 1 shows a contemplated breast support system.

FIG. 2 shows a contemplated breast support system.

FIG. 3 shows a contemplated breast support system.

### SUMMARY OF THE SUBJECT MATTER

A breast support system, bra and related apparel are disclosed that comprise a support member having an outer surface and an inner surface, wherein the support member comprises at least one antibacterial material, at least one anti-absorbent material, at least one antimicrobial material or a combination thereof.

### DETAILED DESCRIPTION

Surprisingly, a breathable, sanitary, antibacterial, anti-absorbent and antimicrobial breast support, bra and related apparel has been produced that can provide adequate support, attractive contour, and the flexibility of being utilized in a number of different apparel items, such as halter tops, shirts, strapless dresses and the like.

Specifically, contemplated embodiments of a breast support system is disclosed that comprises a support member having an outer surface and an inner surface, wherein the support member comprises at least one antibacterial material, at least one antimicrobial material or a combination thereof.

Contemplated support members may comprise individual shaped cup portions that are designed to adhere to a woman's skin without the use of straps or additional material. These types of support members are typically utilized with strapless, backless and/or cleavage-showing clothing where a larger support member would be unsightly or not necessary.

Support members may also comprise a material section that is coupled to the shaped cup portions and is designed to extend around a women's torso, such that the shaped cup portions do not need to adhere to a woman's skin, but instead are held against a woman's body by the material section.

The material section may comprise a closure device, such as a series of snaps, VELCRO®, a series of hooks or another appropriate closure device. The material section may also be continuous, such as one might see with a sport's bra.

Contemplated support members may also comprise at least one strap that is designed to couple to the support member, extend over a woman's shoulders and couple with at least part of the material section. In many instances, there are a plurality of straps, but in some designs, such as a razor bra design—there may technically only be one strap.

Contemplated support members, material portions and additional components comprise an outer surface and an inner surface, wherein the inner surface contacts—at least in part—the surface of a woman's skin. Contemplated outer surfaces are those surfaces that do not contact the surface of a woman's skin. Contemplated support members, material portions and additional components may also comprise padding, pads or other enhancement materials that may comprise at least one antibacterial material, at least one anti-absorbent material, at least one antimicrobial material or a combination thereof. Some of these materials are referred to as “poison-free” in that the wearer experiences no growth of bacteria, microbes or any other unwanted and unsafe growths. Contemplated padding, pads, molded pads or other enhancement materials may also comprise any suitable natural or synthetic material, as long as there is at least one antibacterial material, at least one anti-absorbent material, at least one antimicrobial material or a combination thereof present in the bra, breast support or related apparel.

Contemplated support members, material sections and/or combinations thereof may comprise at least one antibacterial material, at least one anti-absorbent material, at <least one antimicrobial material or a combination thereof. Contemplated materials include anti-absorbent silicon, antibacterial silicon or a combination thereof. Contemplated materials may comprise a fabric that is designed to be antibacterial, antimicrobial or a combination thereof or may comprise a conventional fabric, such as nylon or SPANDEX®, that is coated or otherwise treated with an antibacterial coating, antimicrobial coating or combination thereof. In some embodiments, these coatings comprise carriers that contain antibacterial agents, anti-absorbent agents, antimicrobial agents or a combination thereof. Some contemplated materials may comprise those that have traditionally been used for bandages or dressings. Contemplated support members, material sections and/or combinations thereof may also comprise any suitable natural or synthetic material, including SPANDEX™, NYLON™, cotton, polyester and related materials, and combinations thereof.

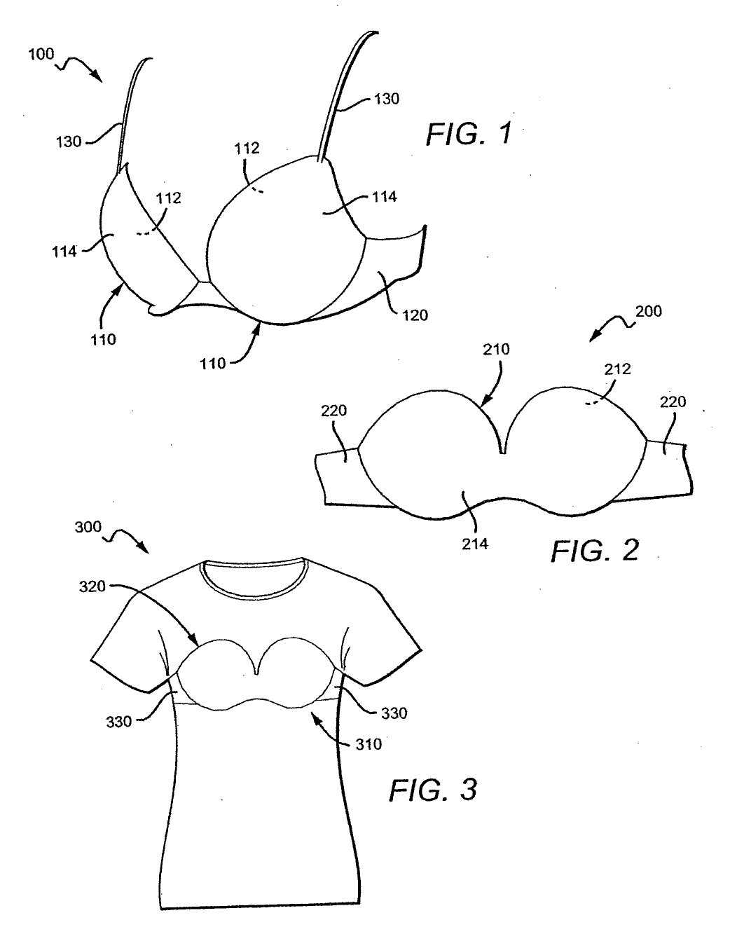

Contemplated breast support systems may comprise any suitable design, such as a maternity/nursing bra, a sports bra, a strapless bra, a conventional bra design, and individual breast supports, such as those shown in U.S. Pat. No. 7,278,899 and in FIGS. 1-3. It should be understood that there is no limit to the design options for these types of antibacterial and/or antimicrobial materials. In addition, contemplated breast support systems may be coupled to or built into a piece of apparel, such as a shirt, a dress or a halter top, so that the wearer does not need a separate breast support system. In FIG. 1, a traditional bra 100 is shown comprising support members 110 having inner surfaces 112 and outer surfaces 114 and a plurality of material sections 120 and 130. In this Figure, the closure mechanism is not shown, along with the back side of the bra. FIG. 2 shows a strapless bra 200 comprising support members 210 having inner surfaces 212 and outer surfaces 214 and material section 220. In this Figure, the closure mechanism is not shown, along with the back side of the bra. FIG. 3 shows a shirt 300 having an incorporated breast support system 310 into the shirt. The breast support system 310 includes support members 320 and a plurality of material sections 330. The back of the breast support system and the shirt are not shown.

Contemplated breast support systems may comprise any suitable color or combination of colors depending on the individual needs of the customer, vendor or application.

Thus, specific embodiments and applications of an antibacterial, anti-absorbent and antimicrobial breast support, bra and related apparel and uses thereof have been disclosed. It should be apparent, however, to those skilled in the art that many more modifications besides those already described are possible without departing from the inventive concepts herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A breast support system, comprising:
a support member having an outer surface and an inner surface, wherein the support member comprises at least one antibacterial material, at least one anti-absorbent material at least one antimicrobial material or a combination thereof.

2. The breast support system of claim 1, wherein the support member further comprises a plurality of straps designed to extend over the shoulders of a wearer.

3. The breast support system of claim 1, wherein the support member is coupled with a piece of apparel.

4. The breast support system of claim 3, wherein the piece of apparel comprises a shirt, a dress or a halter top.

5. The breast support system of claim 1, wherein the at least one antibacterial material comprises anti-absorbent silicon, antibacterial silicon or a combination thereof.

6. The breast support system of claim 1, wherein the support member comprises a combination of at least one antibacterial material and at least one antimicrobial material.

7. The breast support system of claim 1, wherein the support member comprises at least one fabric that is coated with at least one antibacterial material, at least one antimicrobial material or a combination thereof.

8. The breast support system of claim 7, wherein the at least one antibacterial material, at least one antimicrobial material or a combination thereof comprises a carrier material that contains or is otherwise bound to at least one antibacterial agent, anti-absorbent agent, at least one antimicrobial agent or a combination thereof.

9. A bra, comprising:
a support member having an outer surface and an inner surface, wherein the support member comprises at least one antibacterial material, at least one anti-absorbent material at least one antimicrobial material or a combination thereof; and at least one material section.

10. The bra of claim 9, wherein the support member further comprises a plurality of straps designed to extend over the shoulders of a wearer.

11. The bra of claim 9, wherein the at least one antibacterial material comprises anti-absorbent silicon, antibacterial silicon or a combination thereof.

12. The bra of claim 9, wherein the support member comprises a combination of at least one antibacterial material and at least one antimicrobial material.

13. The bra of claim 12, wherein the support member comprises at least one fabric that is coated with at least one antibacterial material, at least one antimicrobial material or a combination thereof.

14. The bra of claim 12, wherein the at least one antibacterial material, at least one antimicrobial material or a combination thereof comprises a carrier material that contains or is otherwise bound to at least one antibacterial agent, anti-absorbent agent, at least one antimicrobial agent or a combination thereof.
